(19) United States
(12) Patent Application Publication
(10) Pub. No.: US 2007/0240199 A1
(43) Pub. Date: Oct. 11, 2007

(54) Identification Label

(76) Inventor: Mark Ronald Wood, East Grinstead (GB)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/575,266

(22) PCT Filed: Nov. 2, 2005
(86) PCT No.: PCT/GB05/04226

§ 371 Date: Mar. 14, 2007

(30) Foreign Application Priority Data
Nov. 3, 2004 (GB) 0424376.2

(51) Int. Cl. G07C 9/00

(52) U.S. Cl. 726/2

(57) ABSTRACT

An identification label (10) includes a microprocessor (38), a display (14), a keyboard (16) and a memory means for storing a security code and a plurality of editable screens of text, the label (10) being arranged to wake up from a sleep mode and display a start screen (50) selected from a plurality of screens of text for a predetermined period of time when the label is activated, and in which preselection of the screen of text be displayed and editing of screens of editable text can be effected only after inputting a security code via the keyboard (10).

This invention relates to identification labels and in particular, but not exclusively, to such labels in the form of tags which can be attached to persons or objects, for example, personal possessions.

Identification labels and tags are well known in which a desired identifier, for example the name of a person or a destination address, is written on a slip of paper or card which is then attached to the object, for example a suitcase, or placed in a tag behind a protective, transparent plastics panel, the tag being attached to the object.

Whilst being simple such identification labels suffer from some disadvantages. They are essential single use in that a new label is required if the identification is to be changed, for example to replace outward flight destination by the inbound flight destination. Multiple labels may be required if more than one identifier has to be associated with the object. A suitable writing instrument is required and a suitable label has to be to hand whenever a new label is to be made up and the information can be lost if the writing is exposed to rain.

The present invention seeks to provide an identification label which addresses these disadvantages.

The present invention is an identification label which includes a microprocessor, a display, a keyboard and a memory means for storing a security code and a plurality of editable screens of text, the label being arranged to wake up from a sleep mode and display a start screen selected from the plurality of screens of text for a predetermined period of time when the label is activated, and in which preselection of the screen of text to be displayed and editing of screens of editable text can be effected only after inputting a security code via the keyboard.

In use, the desired start screen will be selected and the label will go into sleep mode to conserve battery power. If someone needs to see the information, the label is activated to display the screen of information. The label can be arranged to be activated on touching a specific key or any key of the keypad, for example. As a security measure, only a person with knowledge of the security mode, e.g. PIN code, can select the start screen to be displayed on activation of the label or edit any of the editable screens.

The identification label may be arranged to display a screen which includes a primary menu of operational options when a menu key is pressed within the predetermined period of time, failing which the label automatically enters the sleep mode, the label including means to permit activation of one of the operational options on the displayed primary menu. The operational options may include displaying a screen of text, editing a screen of text, and setting the start screen.

Advantageously, on activating the option of editing a screen, the label may be arranged to display a screen including a secondary menu including a menu of the editable screens, from which a screen to be displayed can be selected. In a preferred arrangement the label is arranged to determine if the screen to be displayed is a secure screen, in which case the screen will only be displayed on prior entry of the security code, and, if not, to display the selected screen for a predetermined period of time or until the display is turned off.

This provides that someone inspecting the information stored in the label will only be able to access those screens deemed to be freely accessible. For example, if the start screen is set to display the outward bound flight details when the user has stored his or her travelling information it may be undesirable for persons to be able to identify their home address by accessing the label. They cannot do so, without the security code, if the home address screen is a secure screen.

Advantageously, on activating the option of editing a screen, the user may be prompted to enter the security code on receipt of which the label is arranged to display a screen including a secondary menu of the editable screens from which a screen to be edited can be selected, the label being arranged to then display the selected screen and to allow editing of the screen by means of the keyboard.

The label may be arranged so that the secondary menu entries are editable so the label can be tailored to different uses, the secondary menu entries appearing as the headings on respective editable screens with which the entries are associated.

Also advantageously, on activating the option of setting the start screen, the user is prompted to enter the security code on receipt of which the label is arranged to display a screen including a secondary menu of the editable screens from which the start screen can be selected.

The menu may also include a power down option which, if selected, causes the label to enter the sleep mode.

The label may be arranged such that on first being connected to a power supply, to prompt the user to input a security code which is then stored in the memory.

Embodiments of the invention will now be described, by way of example only, with reference to the accompanying Figures, in which:

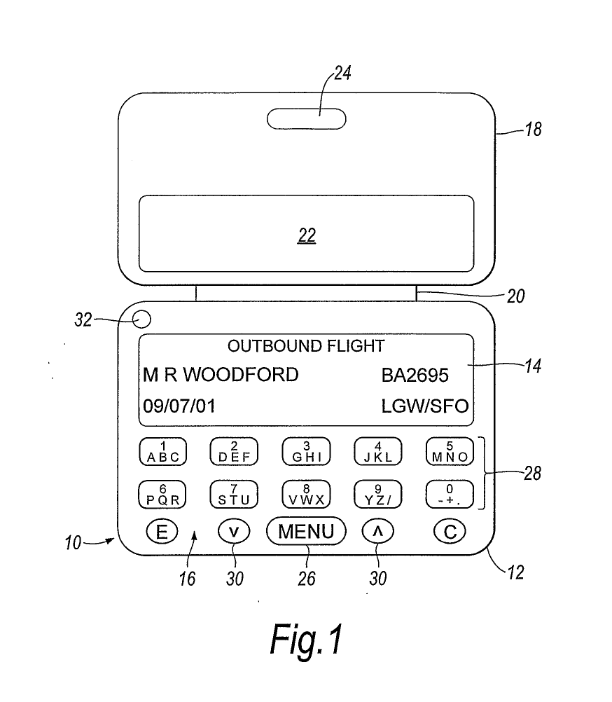

FIG. 1 is a schematic drawing of an embodiment of the present invention;

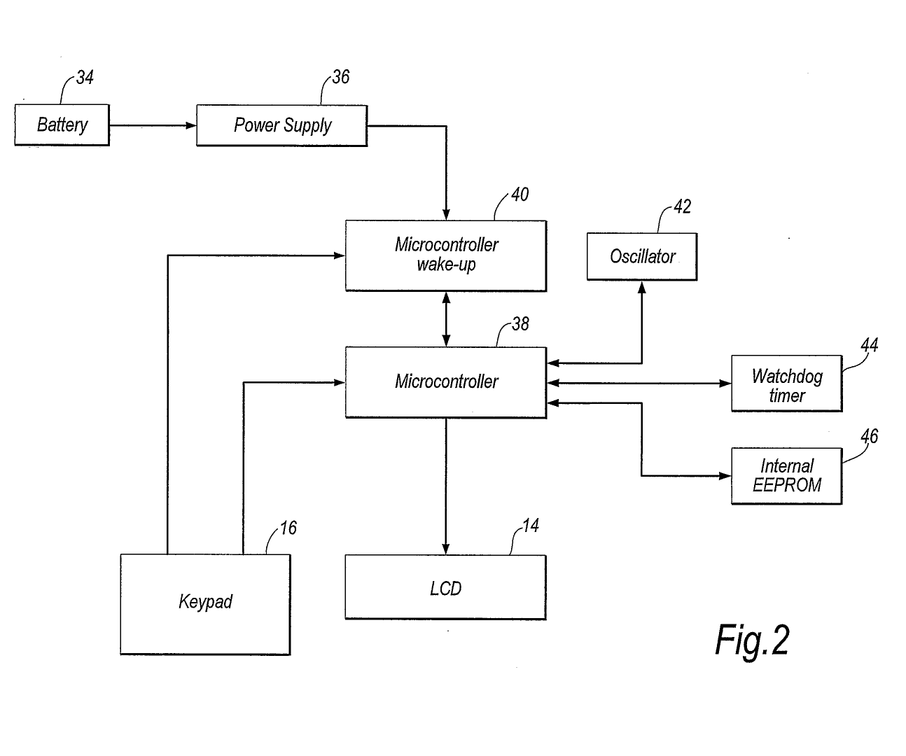

FIG. 2 is a schematic diagram of the circuitry of the embodiment of FIG. 1;

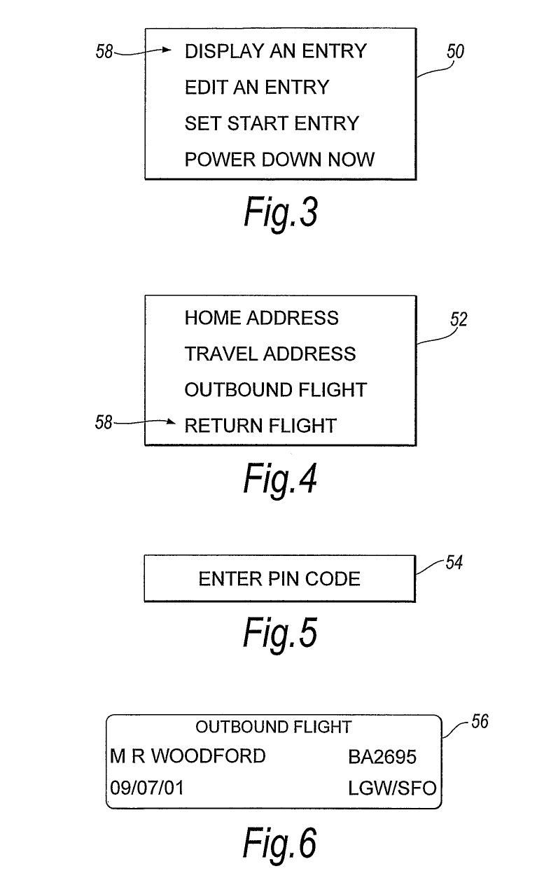

FIG. 3 is a view of a primary menu of the embodiment of FIG. 1;

FIG. 4 is a view of the secondary menu of the embodiment of FIG. 1;

FIG. 5 is a view of the security code menu of the embodiment of FIG. 1;

FIG. 6 is a view of a start screen of the embodiment of FIG. 1; and

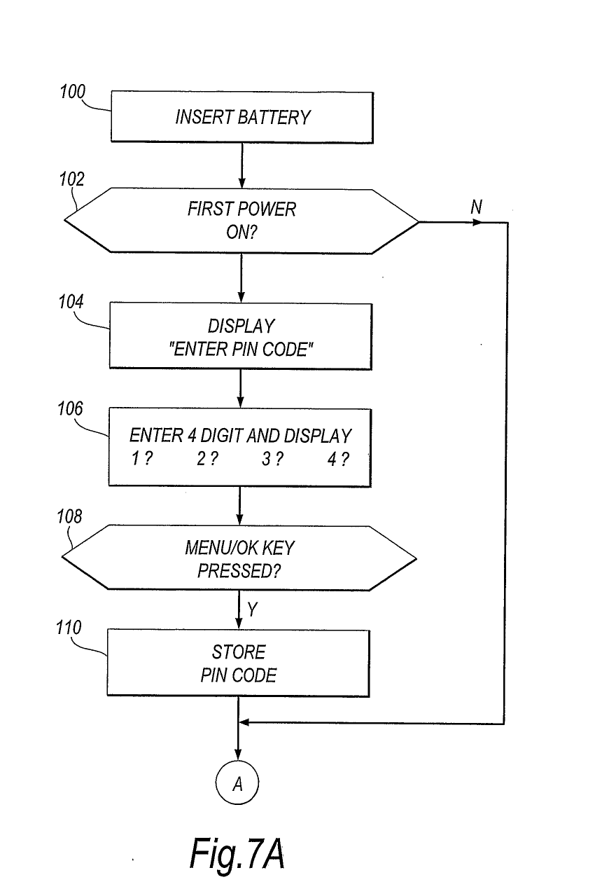

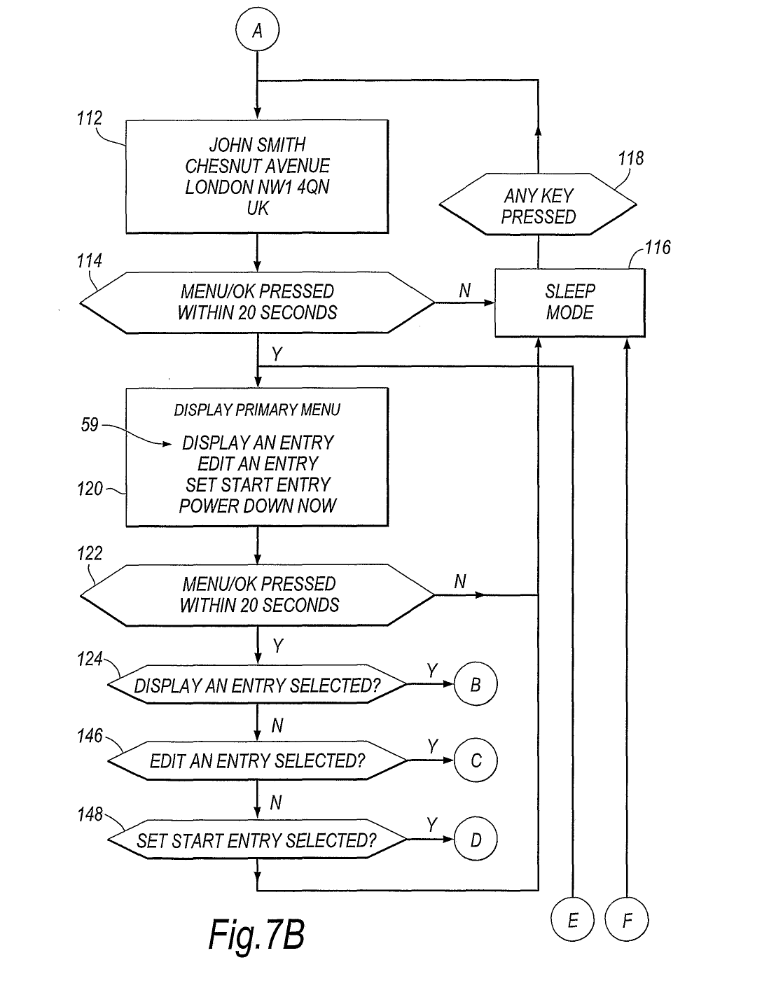

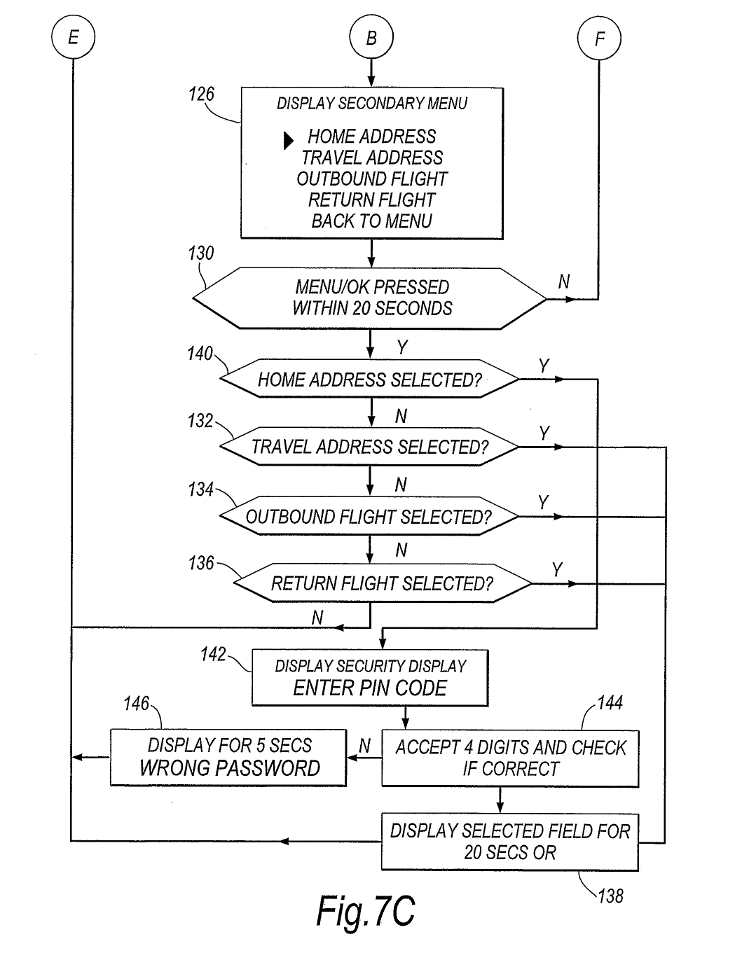

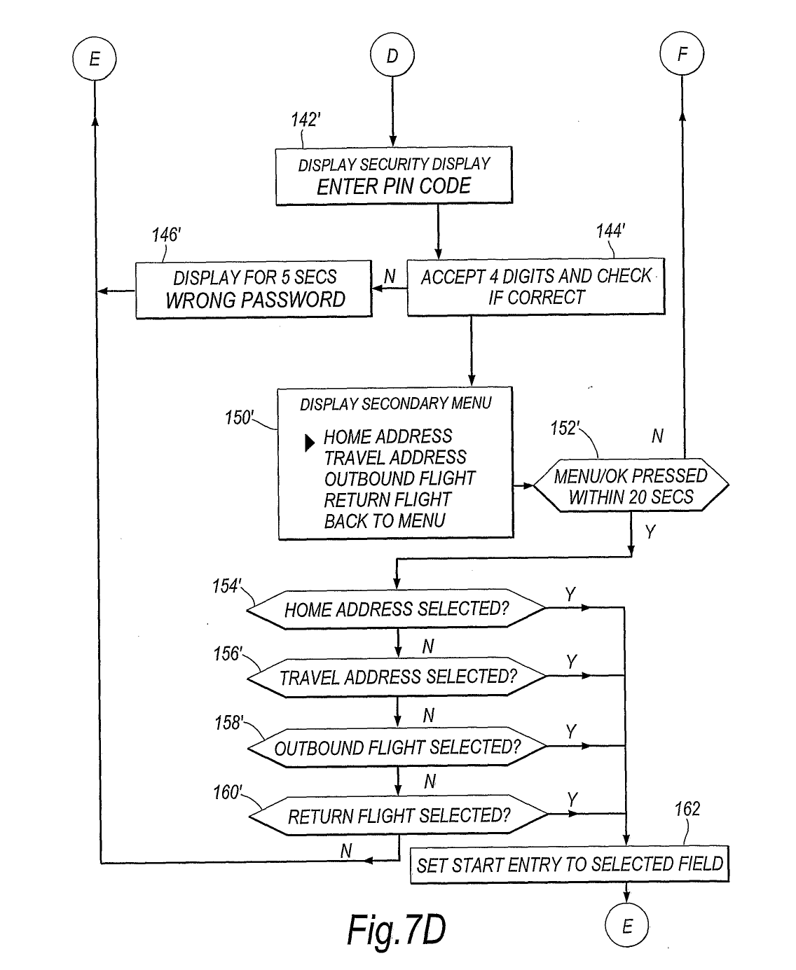

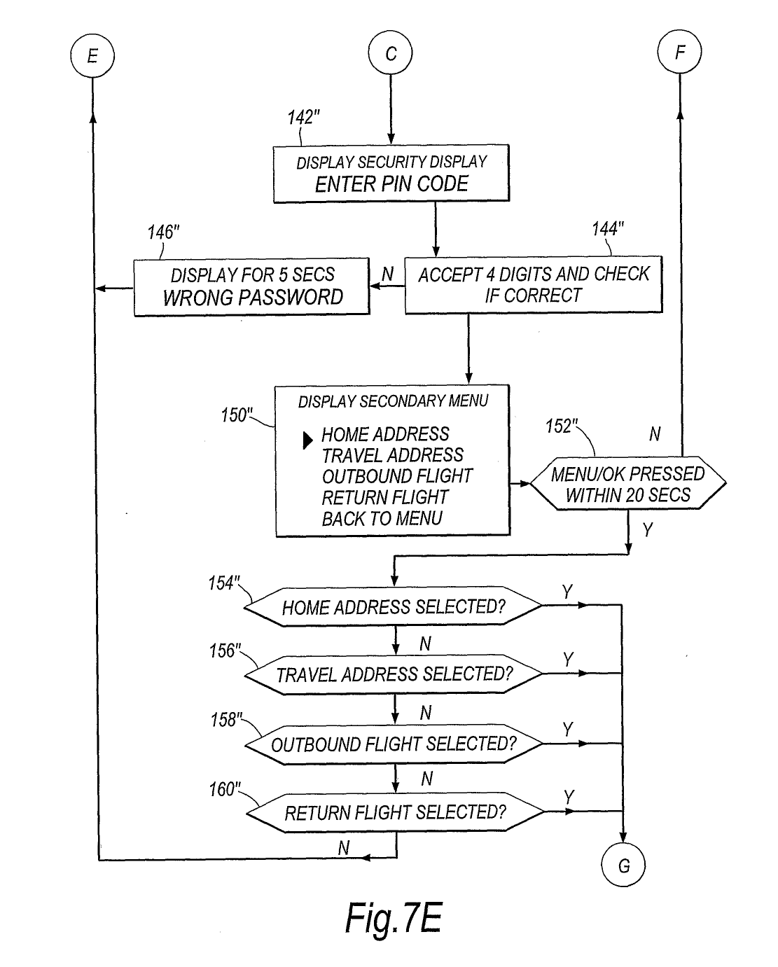

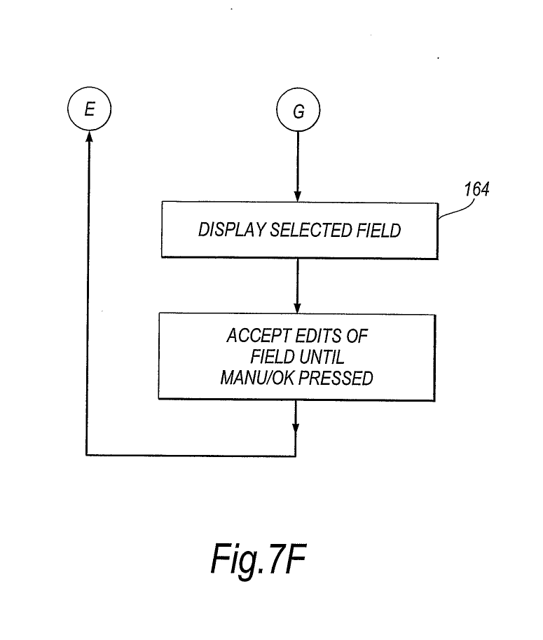

FIGS. 7A to 7F together constitute a flow chart of the operation of the embodiment of FIG. 1.

Referring to FIG. 1 an identification label 10 according to the present invention includes a housing 12 including an LCD display 14 and a keyboard 16. A cover 18 is attached to the housing 12 by a flexible connector 20 which allows the cover 18 to be folded over the housing 12. The cover 18 is shown foreshortened in FIG. 1 being depicted at an angle to the plane of the cover 12.

The cover 18 has a first aperture 22 and second aperture 24 which have the same dimensions as the display 14 and a menu key 26. These apertures allow the display 14 to be seen and the menu button 26 to be pressed when the cover 18 is closed over the housing 12. The keyboard 16 includes alphanumeric input keys 28 and a pair of scroll keys 30 as well as menu key 26.

The housing holds the labels electronic components and battery (not shown).

The housing has a throughhole 32 whereby the label can be attached to an object.

Referring now to FIG. 2 there is shown, diagrammatically, the operative components of the label of FIG. 1, namely a battery 34 powering a power supply 36 the power from which is supplied to a microcontroller 38 (microprocessor) via a microcontroller wake-up circuit (40). The microcontroller 38 and microcontroller wake-up circuit 40 receive inputs from the keypad 16. The microcontroller 38 is also connected to the display an oscillator 42, a watchdog timer 44 and an EEPROM 46.

The EEPROM 46 stores a security code, in this embodiment a four-digit number, and a plurality of editable screens of text together with non-editable screens of text including menus and user prompts examples of which are depicted in FIG. 3. In particular, FIG. 3 is a primary menu 50 which lists available operational options, FIG. 4 is a secondary menu 52 which lists the screens of text which are editable and may be selected as the start screen, FIG. 5 is a prompt 54 for the user to enter their PIN code, ie. security code, and FIG. 6 is an example of an editable screen of text, in this case the details of an outboard airplane flight 56.

The menus 50 and 52 also include an identifier 58 which allows user selection of a menu item. The identifier 58 is movable up and down the menu items by use of scroll keys 30 and the identified menu item selected by pressing the menu key 26.

The operation of this embodiment will now be described with reference to flowchart FIGS. 7A to 7F.

A battery is inserted into the label (step 100). The microcontroller 38 determines this is the first power on of the label (step 102) and it displays an “ENTER PIN CODE” prompt (step 104) whereafter the label accepts entry of four digits as a PIN code (step 106). When the desired PIN code has been entered and is displayed the user presses the MENU key 26 which is detected by the label (step 108) and the PIN code is then stored in the EEPROM 46 (step 110) and the device operation continues to (A) of FIG. 7B, as it does if the battery was inserted and determined at step 102 not to be first power on of the label.

The label next displays a preselected start screen, or a blank display if the first power on (step 112). If the MENU key is not pressed within 20 seconds, in this embodiment (step 114), the label reverts to sleep mode (step 116) until any key is pressed (step 118) whereupon the start screen is displayed (step 112).

If the MENU key 26 is pressed within 20 seconds (step 114) the primary menu 50 is displayed (step 116). The identifier 59 can be moved to select a desired menu item by scroll keys 30. Again, if the MENU key 26 is not pressed within 20 seconds (step 120) the label reverts to sleep mode (step 122). If the MENU key 26 is pressed at step 122 the label's operation depends on the menu item selected on the primary menu 59.

If “power down” is selected the label will revert to sleep mode (step 116).

If “display an entry” of the primary menu 59 is selected the label continues at (B) of FIG. 7C (step 124) which is as follows. The secondary menu 52 is displayed (step 126) from which a screen can be selected (step 130). If not selected within 20 seconds the label reverts to sleep mode (step 116). If “back to menu” is selected the label will display the primary menu 50 once more (step 12). If “travel address”, “outbound flight” or “return flight” is selected (steps 132 to 134 and 136, respectively) the selected screen of text is displayed for 20 seconds (step 138) after which the primary menu 50 is once again displayed.

These screens are considered, in this embodiment, to be non-secure in the sense that any person having access to the label is free to view these screens of information. If, however, “home address” is selected (step 140) this is classified, in this embodiment, as secure information which may be viewed only on entry of the correct security code. Accordingly, the user is prompted to enter the security (PIN) code (step 142). If entered correctly (step 144) the “home address” screen will be displayed (step 138). If the wrong security code is entered at step 144, however, the user is notified for 5 seconds that the entered security code is incorrect (step 146) whereafter the primary menu 50 is once again displayed (step 120).

Referring once again to FIG. 7B and the primary menu 50 displayed at step 120, if “edit an entry” or “set start entry” is selected (steps 146 and 148, respectively) the same requirement to enter the correct password as described above in relation to displaying the home address screen is present. These are shown as steps 142′, 144′, 146′ in FIG. 7D and 142″, 144″ and 146″ in FIG. 7E and which are as steps 142, 144 and 146 of FIG. 7C. In both these cases, if the correct security code is entered the secondary menu 52 is displayed (step 150′, 150″). If a menu item is not selected within 20 seconds (step 152′, 152″) the label reverts to sleep mode (step 116).

If “back to menu” is selected the primary menu 50 is once again displayed (step 120). If the “home address”, “travel address”, “outbound flight” or “return flight” is selected (step 154′, 156′ and 160′, step 154″, 156″ and 160″).

If the selection was concerned with setting the start entry, the identity of the selected start screen is stored in the EEPROM 46 (step 162) and this screen of text is displayed at step 112) and the label reverts to sleep mode (step 116).

If the selection was connected with editing the selected screen then (referring now to FIG. 7F) the selected text of screen is displayed and the screen may now be edited under control of the microcontroller 38 via the keyboard 16. Once edited as desired the MENU key 16 is pressed and the label reverts to sleep mode (step 112).

The label of the present invention has been described in relation to the exemplary embodiment of the accompanying drawings, the form of a key attachable to an object. Other forms of label are envisaged with in the scope of the present invention. The label may be made as an integral part of an item, for example, a suitcase. The label could be arranged to allow variation of the other affects of the label by the user, for example the time period for which screens are displayed before the sleep mode is reinstated.

1. An identification label including a microprocessor, a display, a keyboard and memory means for storing a security code and a plurality of editable screens of text, the label being arranged to wake up from a sleep mode and display a start screen selected from the plurality of screens of text for a predetermined period of time when the label is activated, and in which preselection of the screen of text to be displayed and editing of screens of editable text can be effected only after inputting a security code via the keyboard.

2. An identification label as claimed in claim 1, arranged to display a screen which includes a primary menu of operational options when a menu key is pressed within the predetermined period of time, failing which the label automatically enters the sleep mode, the label including means to permit activation of one of the operational options on the displayed primary menu.

3. An identification label as claimed in claim 2, in which the operational options include displaying a screen of text, editing a screen of text, and setting the start screen.

4. An identification label as claimed in claim 3, in which on activating the option of editing a screen the label is arranged to display a screen including a secondary menu including a menu of the editable screens, from which a screen to be displayed can be selected.

5. An identification label as claimed in claim 4, in which the label is arranged to determine if the screen to be displayed is a secure screen, in which case the screen will only be displayed on prior entry of the security code.

6. An identification label as claimed in claim 4, in which the label is arranged to determine if the screen to be displayed is a secure screen, and, if not, to display the selected screen for a predetermined period of time or until the display is turned off.

7. An identification label as claimed in claim 3, in which on activating the option of editing a screen, the user is prompted to enter the security code on receipt of which the label is arranged to display a screen including a secondary menu of the editable screens from which a screen to be edited can be selected, the label being arranged to then display the selected screen and to allow editing of the screen by means of the keyboard.

8. An identification label as claimed in claim 3, in which on activating the option of setting the start screen, the user is prompted to enter the security code on receipt of which the label is arranged to display a screen including a secondary menu of the editable screens from which the start screen can be selected.

9. An identification label as claimed in claim 3, in which the menu includes a power down option which, if selected, causes the label to enter the sleep mode.

10. An identification label as claimed in any preceding claim which is arranged, on first being connected to a power supply, to prompt the user to input a security code which is then stored in the memory.

11. An identification label substantially as hereinbefore described with reference to, and/or as shown in, the accompanying drawings.
